(19) United States
(12) Patent Application Publication
(10) Pub. No.: US 2021/0101563 A1
(43) Pub. Date: Apr. 8, 2021

(54) SECURE VEHICLE COMPARTMENT ACCESS

(71) Applicant: VAIS Technology LTD, Englewood, CO (US)

(72) Inventor: Vladimir Azarko, Castle Rock, CO (US)

(73) Assignee: VAIS Technology LTD, Englewood, CO (US)

(21) Appl. No.: 17/004,101

(22) Filed: Aug. 27, 2020

Related U.S. Application Data
(60) Provisional application No. 62/909,942, filed on Oct. 3, 2019.

(51) Int. Cl. B60R 25/24; B60R 25/20; B60R 25/25; G06F 21/32; G06F 16/9035; H04W 4/80

(52) U.S. Cl. CPC B60R 25/241; B60R 25/2018; B60R 25/25; G06F 2221/2113; G06F 16/9035; H04W 4/80; G06F 21/32

(57) ABSTRACT

Systems and methods to provide secure access for authenticated and authorized users to vehicle compartments. In one embodiment, user access to a secure vehicle compartment is determined using a sensor measurement of the user, the sensor measurement corresponding to a particular authenticated user with particular user authorization settings as stored in a user profile database. A user profile database maintains a mapping of user profiles that provide user authorization settings and user authentication values

### CROSS-REFERENCE TO RELATED APPLICATION

This application is a nonprovisional patent application of and claims the benefit of U.S. Provisional Patent Application No. 62/909,942, filed Oct. 3, 2019 and titled “System and Method for Secure Vehicle Compartment Access,” the disclosure of which is hereby incorporated herein by reference in its entirety.

### FIELD

The disclosure relates generally to systems and methods for secure vehicle compartment access, and in particular to systems and methods to provide secure access for authenticated and authorized users to vehicle compartments.

### BACKGROUND

Conventional vehicle compartments are unsecured and therefore prone to theft of stored contents. Some vehicle compartments include a locking mechanism, such as a conventional key, which do not allow selective access control. For example, if a party has the convention key, access is granted. Also, conventional keyed access to vehicle compartments can present a safety hazard in that a driver may attempt to unlock the compartment while driving.

What is needed is a system that provides secure access to a vehicle compartment, in particular systems and methods that allows selectable secure access for authenticated and authorized users to a vehicle compartment. This disclosure solves this need. In one embodiment, the authentication process is a multi-step process to allow additional security of vehicle compartment access. In another embodiment, the selectable secure access is adjustable with vehicle state.

By way of providing additional background, context, and to further satisfy the written description requirements of 35 U.S.C. § 112, the following references are incorporated by reference in entirety: U.S. Pat. Appl. Nos. 2018/0124040 to Watson; 2010/0194885 to Plaster; 2018/0370363 to Vinogradov; and 2019/0039659 to Glickman; WIPO Pat. Appl. No. 2018/111264 to Luo; and U.S. Pat. No. 6,960,990 to McKibbon and U.S. Pat. No. 8,556,320 to Yamagishi.

### SUMMARY

Systems and methods are disclosed to provide secure access for authenticated and authorized users to a vehicle compartment of a vehicle. The user is authenticated for potential access to the vehicle and/or the vehicle compartment and allowed access to the vehicle and/or vehicle compartment as authorized. A user profile database maintains a mapping of user profiles that provide user authorization settings and user authentication values.

In one embodiment, a system providing secure access to a vehicle compartment is disclosed, the system comprising: a first vehicle security sensor that provides a first measurement of a vehicle user; a user profile database that stores a set of vehicle user profiles comprising vehicle user authorization settings; a secure vehicle compartment operating in a locked state and an unlocked state, the locked state being a default state; and a vehicle processor that receives the first measurement and communicates with the user profile database to search for a particular vehicle user profile of a particular vehicle user that corresponds with the first measurement; wherein: if the first measurement corresponds with the particular vehicle user profile, the particular vehicle user profile is accessed from the set of vehicle user profiles; if the particular vehicle user profile indicates that the particular user is authorized to access the secure vehicle compartment, the vehicle processor sets the secure vehicle compartment to the unlocked state; and the particular vehicle user accesses the secure vehicle compartment.

In one aspect, the system further comprises a vehicle profile database comprising a set of vehicle profile data, the set of vehicle profile data mapping a set of vehicle states with a set of secure vehicle compartment accessibility states. In another aspect, the secure vehicle compartment is an interior center console vehicle compartment. In another aspect, the first vehicle security sensor is a biometric sensor providing a biometric measurement of the vehicle user; and the set of vehicle user profiles comprise biometric measurements. In another aspect, the vehicle processor is associated with a vehicle electronic control unit. In another aspect, the first vehicle security sensor communicates with a portable electronic device coupled to the vehicle user to obtain the first measurement. In another aspect, the first measurement is communicated by way of at least one of Near-Field Communication (NFC) and Bluetooth. In another aspect, the system further comprises a vehicle state sensor measuring a vehicle state, wherein the secure vehicle compartment remains in a locked state based on the vehicle state.

In another embodiment, a method of providing secure access to a vehicle compartment of a vehicle is disclosed, the method comprising: providing a first vehicle security sensor that provides a first sensor measurement of a vehicle user; providing a user profile database that stores a set of vehicle user profiles comprising vehicle user authorization settings; providing a secure vehicle compartment operating in a locked state and an unlocked state, the locked state being a default state; providing a vehicle processor that receives the first sensor measurement and is in communication with each of the user profile database and the secure vehicle compartment; and searching the user profile database to determine if the first measurement corresponds with a particular vehicle user profile in the user profile database; wherein: if the first measurement corresponds with the particular vehicle user profile, the particular vehicle user profile is accessed from the set of vehicle user profiles to determine if the particular vehicle user is nominally authorized to access the secured vehicle compartment; and if the particular vehicle user is nominally authorized to access the secure vehicle compartment, the vehicle processor sets the secure vehicle compartment to the unlocked state and the particular vehicle user accesses the secure vehicle compartment.

In one aspect, the method further comprises the step of providing a second vehicle security sensor providing a second sensor measurement of a vehicle user, the second sensor measurement compared with the particular vehicle user profile to determine an override of a nominal authorization to access the secure vehicle compartment, wherein an override sets the secure vehicle compartment to the locked state. In another aspect, the second measurement is a measurement of a biometric of the vehicle user. In another aspect, the first sensor measurement is obtained while the vehicle user is positioned exterior to the vehicle. In another aspect, the unlocked state is temporally limited.

In yet another embodiment, a method of multi-step vehicle user authentication to allow vehicle compartment access is disclosed, the method comprising: providing a first sensor that measures a first measurement of a user and a second sensor that measures a second measurement of the user; providing a user profile database that stores a set of user profiles comprising user authorization settings and user authentication values, the user authorization settings comprising a vehicle access authorization and a vehicle compartment authorization; providing a vehicle compartment coupled to a vehicle; providing a vehicle processor that receives each of the first measurement and the second measurement and is in communication with each of the user profile database and the vehicle compartment; matching the first measurement with a first user authentication value of a particular user profile of a particular user in the user profile database; wherein: a first authentication level is provided to the particular user; and if the vehicle access authorization of the particular user profile authorizes the particular user to access the vehicle, the particular user is allowed access to the vehicle; and matching, if the particular user is allowed access to the vehicle, the second measurement with a second user authentication value of the particular user; wherein: a second authentication level is provided to the particular vehicle user; and if the vehicle compartment access authorization of the particular user profile authorizes the particular user to access the vehicle compartment, the particular user is allowed access to the vehicle compartment.

In one aspect, the vehicle compartment is disposed within the vehicle. In another aspect, the vehicle compartment is disposed external to the vehicle. In another aspect, the first measurement is an identification number of a portable electronic device coupled to the particular user. In another aspect, the second measurement is a biometric measurement of the particular user. In another aspect, if the particular user is authorized to access the vehicle, a first communication is sent to a vehicle designee. In another aspect, if the particular user is authorized to access the vehicle compartment, a second communication is sent to a vehicle designee. The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U. S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “computer-readable medium” as used herein refers to any storage and/or transmission medium that participate in providing instructions to a processor for execution. Such a computer-readable medium is commonly tangible, non-transitory, and non-transient and can take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

Various embodiments may also or alternatively be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The disclosure will be readily understood by the following detailed description in conjunction with the accompanying drawings, wherein like reference numerals designate like elements. The elements of the drawings are not necessarily to scale relative to each other. Identical reference numerals have been used, where possible, to designate identical features that are common to the figures.

FIG. 1 is a schematic representation of one embodiment of a secure vehicle compartment access system;

FIG. 2 is a flow chart of one method of use of the secure vehicle compartment access system of FIG. 1; and

FIG. 3 is a flow chart of another method of use of the secure vehicle compartment access system of FIG. 1.

### DETAILED DESCRIPTION

Reference will now be made in detail to representative embodiments. The following descriptions are not intended to limit the embodiments to one preferred embodiment. To the contrary, it is intended to cover alternatives, modifications, and equivalents as can be included within the spirit and scope of the described embodiments as defined, for example, by the appended claims.

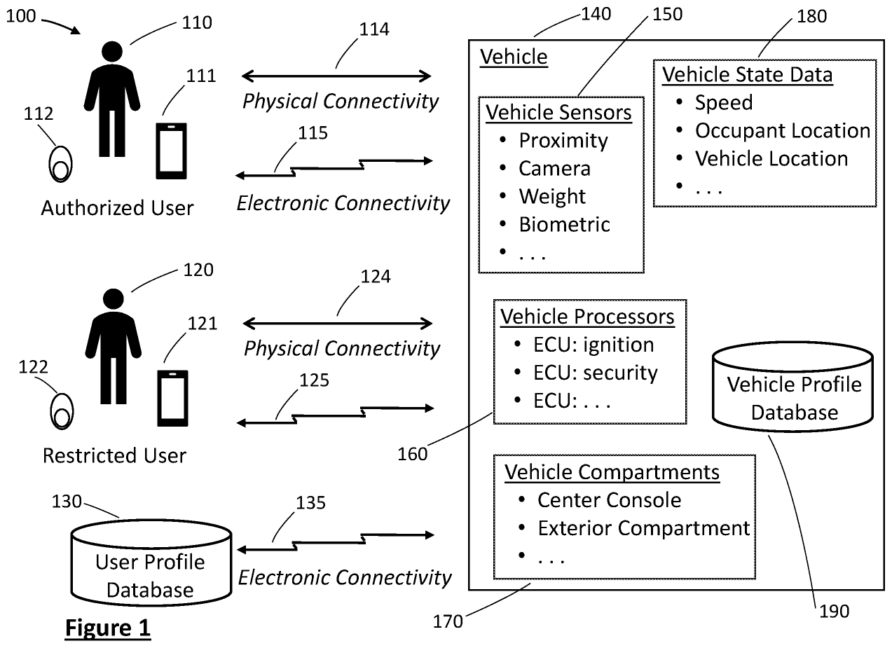

The disclosed devices, systems, and methods of use will be described with reference to FIGS. 1-3. Generally, systems and methods to provide secure vehicle compartment access are provided.

Although the disclosed devices, systems, and methods of use will be described relative to secure vehicle compartment access, the devices, systems, and methods of use have other applications. For example, the secure vehicle compartment access may be used to provide secure access to other devices or systems, such as warehouse or business storage units, shipping containers, residential storage sheds, etc. The term “vehicle” means any device or machine capable of transporting an item, such as people or goods, to include an automobile.

The words “authorize” and “authorization” mean to grant permission for an act or approval to perform an act.

The words “verify” and “verification,” and the words “authenticate” and “authentication” mean to ensure, demonstrate or prove that something is true, genuine, accurate or justified.

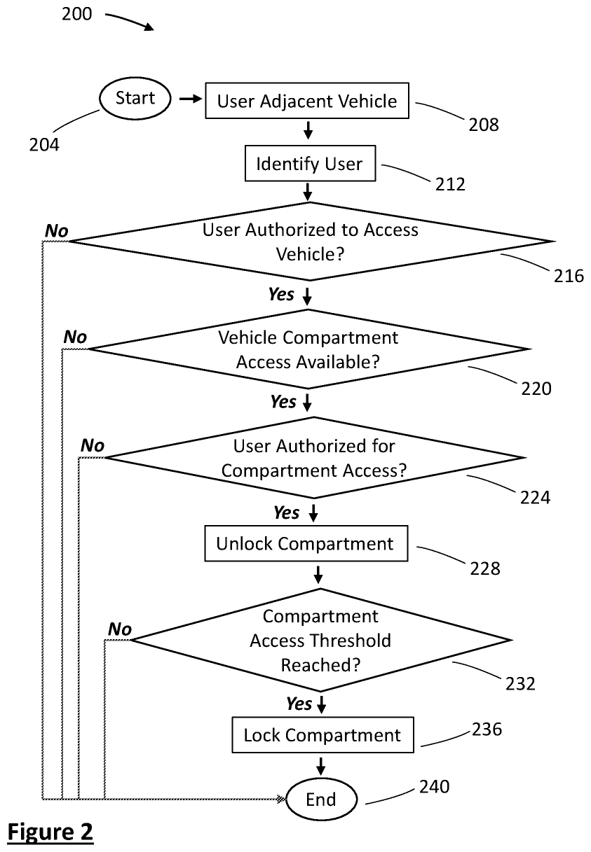

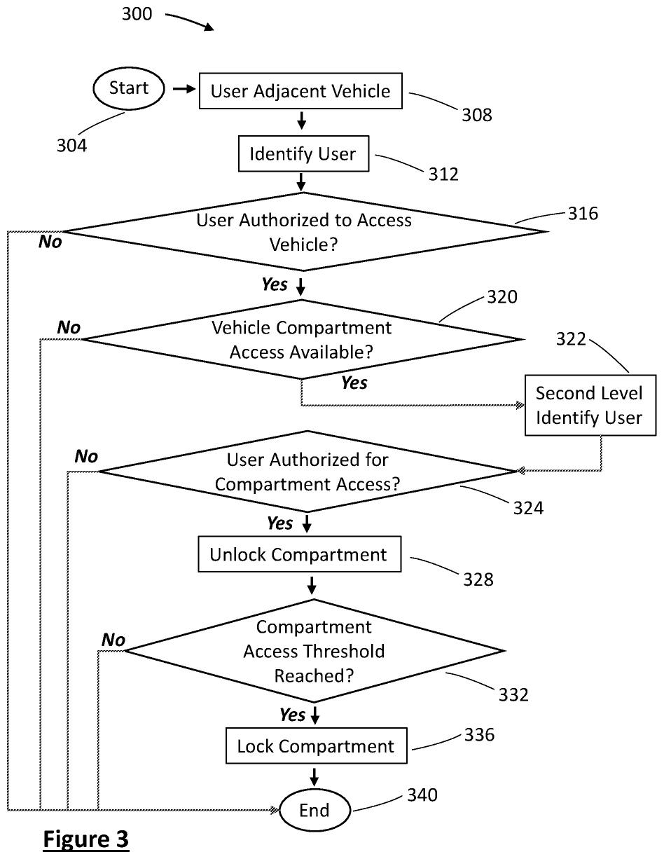

With attention to FIG. 1, a secure vehicle compartment access system 100 is depicted. FIGS. 2 and 3 provide methods of using the secure vehicle compartment access system of FIG. 1. Other methods of use are possible; FIGS. 2 and 3 provide two examples. The secure vehicle compartment access system may also be referred to as “system,” “secure system,” “access system,” and/or “compartment access system.”

Generally, the secure vehicle compartment access system allows controlled secure access to a vehicle compartment for authorized and authenticated (aka verified) users under selectable vehicle and/or user conditions. The access to the vehicle compartment is determined using one or more simultaneous or sequential sensor measurements of the user and/or the vehicle, the sensor measurements corresponding to a particular user with particular user authorization settings, as stored in a user profile database. The user profile database stores a set of user profiles comprising user authorization settings (e.g. one setting indicating if a particular user is authorized for access to a vehicle, another setting indicating if the same particular user is authorized for access to a vehicle compartment) and user authentication values (e.g. a biometric value of a particular user, such as a fingerprint). The access to the vehicle compartment and/or to the vehicle itself may, in some embodiments, be determined using one or more simultaneous or sequential sensor measurements of the user and/or the vehicle, the sensor measurements enabling an access level to be determined through authorization settings stored in one or both of a user profile database and a vehicle profile database. In some embodiments wherein a vehicle has multiple compartments, some users may have access to one compartment but not the other.

The secure vehicle compartment access system 100 generally comprises one or more vehicle sensors 150, vehicle state data 180, one or more vehicle processors 160, one or more vehicle compartments 170, a vehicle profile database 190, and a user profile database 130. The afore-identified elements of the secure vehicle compartment access system 100 are typically disposed on or within a vehicle 140, although not absolutely required. For example, the user profile database 130 may reside, as shown in FIG. 1, external to the vehicle 140, such as in a network of remote computers hosted on the Internet to store, manage, and process data (aka “in the cloud”) or within a mobile electronic device of a user of the secure vehicle compartment access system 100.

The one or more vehicle processors 160 may be electronic control units (ECUs) that are standard for a particular vehicle 140 or may be adapted ECUs. In one embodiment, the one or more vehicle processors 160 may interact with or be a part of one or more ECUs. In another embodiment, the one or more vehicle processors 160 may comprise one or more ECUs.

One or more users may interact with the secure vehicle compartment access system 100. In one embodiment, a fully authorized user 110 (or simply an “authorized user”) is user that is authorized to access both the vehicle 140 and is authorized to access at least one vehicle compartment 170 of the vehicle 140. The authorized user 110 may possess or engage with one or more electronic devices, such as a portable electronic device 111 such as a smartphone, smartwatch, or tablet computer, and an electronic vehicle key 112 such as a key fob. The term “fob” or the phrase “key fob” means a portable device with integrated security measures such as authentication measures that enables controlled and secure access to a device or system, such as a vehicle, and may include factory aka original equipment fobs and customized after-market fobs.

The authorized user 110 interacts with the vehicle 140 by way of one or both of physical connectivity 114 and electronic connectivity 115. For example, the authorized user 110 may touch a door handle of the vehicle 140, or may press a finger to a fingerprint biometric sensor (or NFC, etc.) disposed in the vehicle 140, thereby providing a physical connectivity 114. Electronic connectivity 115 (e.g. of the portable electronic device 111) may include a Bluetooth connectivity function that enables electronic connectivity with one or more vehicle processors 160 or vehicle sensors 150. The term “Bluetooth” means a wireless technology standard for exchanging data between devices over relatively short distances using short-wavelength UHF radio waves. The electronic connectivity 115, 125, 135 may be of any type known to those skilled in the art, to include any wireless communication, such as near-field communication (NFC), Wi-Fi, ultra-wideband (UWB), or Bluetooth communication. Other types of electronic communication are possible, such as those involving electromagnetic fields (e.g. low frequency proximity or capacitive proximity sensing type systems), and any electronic communication types or standards known to those skilled in the art. In one embodiment, one or more of the electronic connectivity 115, 125, 135 may be used for user location and/or user proximity in addition to communications.

A restricted user 120 is user that is authorized with restrictions to access the vehicle 140 and/or to access at least one vehicle compartment 170 of the vehicle 140. For example, a restricted user 120 may be authorized to access the vehicle 140 only during daylight hours or may be authorized to access a first vehicle compartment 170 (e.g. an exterior compartment such as a vehicle trunk) but not be authorized to access a second vehicle compartment 170 (e.g. a center console compartment.) The restricted user 120 may possess or engage with one or more electronic devices, such as a portable electronic device 121 such as a smartphone or tablet computer, and an electronic vehicle key 122 such as a key fob. The restricted user 120 interacts with the vehicle 140 by way of one or both of physical connectivity 124 and electronic connectivity 125. The physical connectivity 124 is similar to the physical connectivity 114 described above. The electronic connectivity 125 is similar to the electronic connectivity 115 described above. (Also, the electronic connectivity 135 between the user profile database 130 and the vehicle 140 is similar to the electronic connectivity 114 and 124 described above.)

Further details of the elements of the secure vehicle compartment access system 100 of FIG. 1 will be described in concert with a method of using the secure vehicle compartment access system 100 as depicted in FIG. 2.

FIG. 2 is a flow chart of one method of using the secure vehicle compartment access system 100. In one embodiment of a method of use, the secure vehicle compartment access system 100 follows the sequence of steps described in FIG. 2. Other methods of use are possible, to include a sequence of steps different than those of FIG. 2, a sequence with additional steps, a sequence with fewer steps, and the sequence of steps provided as FIG. 3. Also, as will be clear from the below description, elements of the secure vehicle compartment access system 100 of FIG. 1, and/or other aspects of a secure vehicle compartment access system as described in this disclosure, may be incorporated.

With particular attention to FIG. 2, a flowchart of a method of use of a secure vehicle compartment access system is provided, the method 200 utilizing the elements described in the systems of FIG. 1.

The method 200 starts at step 204 and ends at step 240. Any of the steps, functions, and operations discussed herein can be performed continuously and automatically. In some embodiments, one or more of the steps of the method 200 may comprise computer control, use of computer processors, and/or some level of automation. The steps are notionally followed in increasing numerical sequence, although, in some embodiments, some steps may be omitted, some steps added, and the steps may follow other than increasing numerical order.

At step 208, a user is positioned adjacent or near the vehicle 208. The user may be an authorized user 110, a restricted user 120, or some other type of user, such as an unauthorized user. An unauthorized user would include a bad actor such as a thief interested in stealing the vehicle 140 itself or contents within the vehicle 140, to include property stored in the one or more vehicle compartments 170. As mentioned above, the authorized user 110 and the restricted user 120 may possess or be in contact with one or more electronic devices (that are in electronic connectivity with the vehicle 140 and/or the components of the vehicle 140), such as the respective portable electronic devices 111, 121 respectively and/or electronic key fobs 112, 122 respectively. One or both of the authorized user 110 and the restricted user 120 may possess or be in contact with other electronic devices that provide an electronic connectivity with the vehicle 140 and/or components of the vehicle 140. At the completion of step 208, the method continues to step 212.

At step 212, the identity of the user is determined through searching the user profile database 130 for a match or correspondence between one or more measurements of the user and the user profiles stored in the user profile database 130. A match indicates that the usr or issue, aka the particular user, is authenticated. The one or more measurements are obtained by the one or more vehicle sensors 150. For example, a vehicle sensor may be a Bluetooth capable receiver that receives a Bluetooth signal from a user's smartphone, the Bluetooth signal providing an identification number of the user's smartphone. The sensor transmits the identification number to a vehicle processor 160. The identification numbers of authorized users of the vehicle 140, as stored in the user profile database 130, are accessed by the vehicle processor 160 by way of electronic connectivity 135, wherein of the smartphone identification number is matched with an authorized user 110.

The vehicle sensors 150 may include a variety of sensor types, such as proximity sensors, camera sensors (in any of several bands, to include visual and infrared), weight sensors (positioned, e.g. to measure weight of a user sitting in the driver's seat of vehicle 140), and biometric sensors, such as finger print sensors and any biometric sensor known to those skilled in the art, to include retinal biometric sensors. The one or more vehicle sensors 150 may be used independently or in concert. For example, a visible band camera may image a user, the image used as input to a facial recognition sensor system or a retinal sensor. Sensors 150 may also include NFC, short range proximity based on Wi-Fi, Bluetooth, etc. Sensors based on electromagnetic field (low frequency proximity, capacitive proximity sensing, etc.) may also be used as part of 212, 312, and 322 user identification. The vehicle sensors may be factory-installed (aka original equipment manufacturer's equipment) or customized after-market sensors. In some embodiments, any sensor known to those skilled in the art that may be used to identify a particular user and/or to identify or otherwise categorize a state of the vehicle 140 may be used. (The term “state” and the phrase “vehicle state” mean a condition of a thing or condition of a vehicle, respectively; for example, a vehicle state may include speed, weight distribution, location, etc. of the vehicle. Also, the term “identify” means to authenticate a user as a particular user.)

The user profile database 130 may include user data consistent with the vehicle sensors 150, meaning user data that may be usable to identify or authenticate a particular user given a sensor measurement of or from the user. For example, the user profile database 130 may include data on candidate users (e.g. both authorized users 110 and restricted users 120) such as fingerprint data, retinal data, electronic device identification data (as described in an above example scenario), weight data, height data, etc. The user profile database 130 may also include authorization data for particular users, the authorization data with respect to the one or more vehicle compartments 170 and/or other parameters. For example, the user profile database 130 may indicate that a first user is only authorized assess to the vehicle 110 assuming a valid key fob is identified and specially not authorized access to any vehicle compartments 170, while a second user is provided unrestricted authorized access to the vehicle 110 and all vehicle compartments 170. The user profile database 130 may also couple authorization of a particular user with other vehicle 140 data, such as vehicle state data 180. For example, a particular user may only be granted authorization to access the vehicle 140 (or operate the vehicle 140) when the vehicle state data provides that the vehicle 180 is located in a selectable geographic zone. Other authorization parameters or combinations, as defined in the user profile database 130, are possible. For example, a particular restricted user may be granted access to a particular vehicle compartment (e.g. the center console) only when the vehicle state data 180 provides that the vehicle 140 is not moving. At the completion of step 212, the method continues to step 216.

At step 216, the secure vehicle compartment access system 100 determines if the particular user is authorized to access the vehicle 140. Stated another way, a query is made at step 216 that results in either a “Yes” and proceeding to step 220, or a “No” and proceeding to step 240. As described above, this query to determine authorization to access the vehicle is performed by searching the user profile database 130 for authorization parameters of any user profile that matches or corresponds to a vehicle sensor 150 measurement of a candidate user. (The process of searching a database to particular data based on search data may also be referred to as “mapping” between search data and the particular data). If no user profile matches the vehicle sensor 150 measurement, then the candidate user is denied access to the vehicle, and the method proceeds to step 240 and ends. Also, is a user profile does match the vehicle sensor 150 measurement yet the profile, as stored in the user profile database 150, indicates that the candidate user is not authorized for access to the vehicle 140, the method proceeds to step 240 and ends. If, however, a user profile does match the vehicle sensor 150 measurement and the profile, as stored in the user profile database 150, indicates that the candidate user is authorized for access to the vehicle 140, the method proceeds to step 220.

As described above, this query of step 216 to determine authorization to access the vehicle is performed by searching the user profile database 130 for authorization parameters of any user profile that matches or corresponds to a vehicle sensor 150 measurement of a candidate user. If no user profile matches the vehicle sensor 150 measurement, then the candidate user is denied access to the vehicle, and the method proceeds to step 240 and ends. In one embodiment, a vehicle monitoring or registration network (not shown) may be used to replace or to supplement the identification of the user step. More specifically, the vehicle 140 may communicate with a vehicle monitoring or registration network to determine if a candidate user is authorized for access to the vehicle. If the candidate user is so verified, the user may be granted outright or unconditional access to the vehicle, and the query and matching to the user profile database 130 is not required. Alternatively, if the candidate user is verified by way of the vehicle monitoring or registration network, the candidate user is conditionally authorized to access the vehicle 140, subject to the notional query and matching to the user profile database 130 as described above, thereby supplementing the user identification process.

At step 220, the secure vehicle compartment access system 100 determines if vehicle compartment access is available given the vehicle state data 180 and relevant data in the vehicle profile database 190. Stated another way, a query is made at step 220 that results in either a “Yes” and proceeding to step 224, or a “No” and proceeding to step 240. The vehicle profile database 190 includes data describing vehicle states in which access to a particular vehicle compartment 170 is authorized. For example, the vehicle profile database 190 may provide that access to a center console vehicle compartment 170 is only authorized when the vehicle state data 180 for speed is zero (meaning the vehicle is not moving). As another example, the vehicle profile database 190 may provide that access to a center console vehicle compartment 170 is only authorized when the vehicle state data 180 provide that there is only one occupant in the vehicle 140, as determined by assessing the occupant location data and/or the vehicle sensor data regarding weight on seats in particular areas of the vehicle 140.

At step 224, the secure vehicle compartment access system 100 determines if the particular user is authorized to access a particular vehicle compartment 170 or set of vehicle compartments 170). Stated another way, a query is made at step 224 that results in either a “Yes” and proceeding to step 228, or a “No” and proceeding to step 240. As described above, this query to determine authorization to access a particular vehicle compartment is performed by searching the user profile database 130 for authorization parameters of any user profile that matches or corresponds to a vehicle sensor 150 measurement of a candidate user. Note that the system 100 will have already accessed the user profile database 130 and searched the user profile database 130 using a vehicle sensor 150 measurement as part of step 220, such that all that is further required is to access vehicle compartment 170 authorization data. Also, note that the vehicle compartment 170 authorization data may be a set of data if the system 100 is configured to provide secure access to more than one vehicle compartment 170 (e.g. to an interior center console and an exterior trunk). If the accessed vehicle compartment 170 authorization data, as contained in the user profile 130 database, provides that the particular identified user is not authorized access to the vehicle compartment (or no user is found to match the vehicle sensor 150 measurement of a candidate user), the method proceeds to step 240 and ends. If, however, a user profile does match the vehicle sensor 150 measurement and the profile, as stored in the user profile database 150, indicates that the candidate user is authorized for access to the vehicle compartment 170, the method proceeds to step 228.

Note that in one embodiment, one or more additional user authorization and/or user identification steps may be performed to allow access to a particular vehicle compartment 170. For example, in addition to the identify user step of 212, an additional identify (and thus authenticate) user step may occur just prior to, in concert with, or otherwise be required to allow access to the particular vehicle compartment 170. More specifically, for example, an additional identify user step (like that of step 212) may determine authorization of a candidate user by matching an authorized user, as stored in the user profile database 130, using a matching of the candidate's portable electronic device, while access to a particular vehicle compartment requires a fingerprint or other biometric match.

At step 228, the system unlocks the particular vehicle compartment 170. As discussed above, the vehicle compartment 170 may be a set of vehicle compartments 170, such as an interior center console and an exterior pick-up truck toolbox mounted in the truck bed. In one embodiment, one or more vehicle compartments may have discrete sub-compartments or portions, each with unique authorization parameters, as stored in the user profile database 130 and/or the vehicle profile database 190. For example, a first and second portion of a center console may be authorized for a particular first user, while solely a first portion (and not the second portion) of a center console may be authorized for a second user. Such a demarcation would allow a parent to securely store medicine in a second portion of a center console while denying his teenage son access to the second portion, for example. At the completion of step 228, the method continues to step 232.

At step 232, the secure vehicle compartment access system 100 determines if a compartment access threshold has been reached, such threshold values stored in the vehicle profile database 190. Stated another way, a query is made at step 232 that results in either a “Yes” and proceeding to step 236 or a “No” and proceeding to step 240. The threshold value may be, for example, a time value. For example, the threshold value may allow access to the compartment for a fixed and/or selectable amount of time (a temporal limitation), e.g. for five minutes, and then, upon closure of the compartment after the threshold has been exceeded, the compartment is locked at step 236. If a particular threshold has not been reached, then the step 232 proceeded to step 240 and the method 200 ends.

At step 236, the vehicle compartment 170 is locked. More specifically, one or more of the vehicle processors 160 transmits a signal to the particular vehicle compartment 170 to set the state of the vehicle compartment 170 to a locked state. Each of the one or more vehicle compartments 170 may operate in each of a locked state and an unlocked state. In one embodiment, a particular vehicle compartment 170 may operate or reside in a locked state as a default state. At the completion of step 236, the method 200 ends at step 240.

FIG. 3 depicts another method of use 300 of the system of FIG. 1. The multi-step vehicle user authentication method 300 is similar to that of method 200 of FIG. 2 but includes an additional second user identification step—the “Second Level Identify User” step depicted as step 322. Note that although method 300 employs two authentication steps, the disclosure is not limited to a multi-step authentication method of two steps. Stated another way, in some embodiments a multi-step vehicle user authentication method may comprise more than two steps, such as three steps.

Generally, the method 300 starts at step 304 and ends at step 340. Most of the steps of method 300 are similar if not equivalent to those of method 200 (with the exception of new added step 322), such that the last two digits of a particular step of method 300 are similar if not equivalent to those steps with a matching set of last two digits (that is, step 308 of method 300 is similar if not equivalent to step 208 of method 200, etc.). As in FIG. 2 and method 200, any of the steps, functions, and operations discussed herein with regards to method 300 can be performed continuously and automatically. In some embodiments, one or more of the steps of the method 300 may comprise computer control, use of computer processors, and/or some level of automation. The steps are notionally followed in increasing numerical sequence, although, in some embodiments, some steps may be omitted, some steps added, and the steps may follow other than increasing numerical order.

Upon completion of step 320 (which is, as provided above, similar if not equivalent to step 220 of method 200), the method 300 proceeds to step 322.

At step 322, an additional or supplemental identification (and authentication) of the candidate user is performed. While the step 312 “Identify User” provides an identification of the user for access to the vehicle 140, (this may be termed a “first authentication level”) as determined through e.g. searching the user profile database 130 for a match or correspondence between one or more measurements of the user and the user profiles stored in the user profile database 130, the step 322 provides a second level identification of the user for access to one or more vehicle compartments 170 (this may be termed a “second authentication level). The vehicle sensors 150 may be the same set, a different set, or include a portion of the set of sensors 150 used in the step 312 user identification step. In an embodiment with two sensors used for authentication of a particular user, the first sensor measures a first measurement which is used to match with a first user authentication value of the particular user profile of the particular user in the user profile database, and the second sensor measures a second measurement which is used to match with a second user authentication value of the particular user profile of the particular user in the user profile database.

A scenario involving a valet serves to illustrate the method 300 and the distinction between steps 312 and 322. In such a scenario, a vehicle owner would like the valet to be able to access the vehicle 140 and to operate the vehicle, but to not be able to access the vehicle compartments 170. With respect to the method 300 at steps 312 and 316, the method at step 312 identifies or authenticates the user as a valet user (perhaps, e.g., by way of using a vehicle authentication of the valet user as an authorized user because the valet user is in possession of the key fob 112, the key fob 112 communicating with the vehicle 140 by way of electronic connectivity 115), and at step 316 the valet user is determined to be authorized to access the vehicle 140. However, when the method 300 reaches step 322, a second level of identification of the valet user is performed (perhaps, e.g., using a biometric sensor such as a fingerprint sensor or a retinal scan, NFC, short range proximity based on Wi-Fi, Bluetooth, etc.), the second level of identification or authentication providing input to the query step of step 324, wherein it is determined that the valet user is not authorized to access the vehicle compartments.

Note that the method 300 provides a second independent authorization check on a candidate user to determine if that user is authorized access to the vehicle compartments 170. In contrast, while the method 200 may differentiate users authorized access to solely the vehicle versus both the vehicle and the vehicle compartments (by way of user data stored in the user profile database 130), the method 300 provides a second identification check and thus provides an additional or second layer of security.

The second level or layer of user identification of method 300 enables additional features, such as the ability to perform a truthing or calibration of the user identification means used in step 320, so as to provide a quality check on the two identify user steps of step 312 and step 322. For example, the identification of the candidate user at step 322 may repeat the identification means of step 312 to calibrate the degree of match, thereby providing a means to identify a bad actor attempting to spoof the system; a significantly different degree of match may indicate a bad actor attempting to thwart the authentication process so as to access to the vehicle compartments 170.

In one embodiment, one or more vehicle compartments 170 automatically lock when one or more selected users leave the vehicle 140 and/or when the vehicle 140 moves to a locked state.

In one embodiment, the various states of the one or more vehicle compartments 170, and/or states of other parameters or devices discussed (state of vehicle as to speed or location, state of vehicle compartment access, etc.) may be transmitted from the vehicle 140. For example, an authorized entry into a particular vehicle compartment 170 may trigger a broadcast to the vehicle owner to inform or notice him that a particular authorized user has been given access to a particular vehicle compartment 170.

In one embodiment, the one or more measurements from the one or more vehicle sensors 150 may be broadcast to a selectable party, such as the vehicle owner. For example, upon an authorized entry to the vehicle 140, the secure vehicle compartment access system 100 may broadcast of transmit video of the vehicle interior (and of the authorized user) to the vehicle's owner. Similarly, an unauthorized user that has entered the vehicle, or is lurked around the vehicle for a threshold value of time, may be broadcast to a selectable party.

In one embodiment, authorization to access one or more vehicle compartments 170 may be dictated by terms of a “vehicle sharing use” agreement. Vehicle or car sharing services, such as those by Turo, allow authorized temporary use of a vehicle under terms established between the vehicle's owner and the car sharing service. Typically, a car owner will allow his vehicle to be used for a set period of time under defined terms. For example, the temporary use may authorize driving of the vehicle but does not authorize access to vehicle compartments. Such terms of use may be stored in an accessible database, such as the car sharing service database and/or the vehicle profile database 190.

In one embodiment, the system is integrated with or forms a part of a package delivery vehicle, such as those used by UPS, FedEx, Amazon, etc. wherein package compartments are provided within the package delivery vehicle, an automated door is provided to access one or more compartments, and/or multiple access points are provided to the same compartment.

In one embodiment, the disclosed system works with or is compatible with components and/or systems described in U.S. Pat. Appl. No. 62/927,586 filed Oct. 29, 2019 and entitled “Automotive Authorization Control” which is incorporated by reference in entirety for all purposes.

The exemplary systems and methods of this disclosure have been described in relation to systems and methods involving a secure vehicle compartment access system. However, to avoid unnecessarily obscuring the present disclosure, the preceding description omits a number of known structures and devices, and other application and embodiments. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

A number of variations and modifications of the disclosure can be used. It would be possible to provide for some features of the disclosure without providing others.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system providing secure access to a vehicle compartment, comprising:
a first vehicle security sensor that provides a first measurement of a vehicle user;
a user profile database that stores a set of vehicle user profiles comprising vehicle user authorization settings;
a secure vehicle compartment operating in a locked state and an unlocked state, the locked state being a default state; and
a vehicle processor that receives the first measurement and communicates with the user profile database to search for a particular vehicle user profile of a particular vehicle user that corresponds with the first measurement;
wherein:
if the first measurement corresponds with the particular vehicle user profile, the particular vehicle user profile is accessed from the set of vehicle user profiles;
if the particular vehicle user profile indicates that the particular user is authorized to access the secure vehicle compartment, the vehicle processor sets the secure vehicle compartment to the unlocked state; and
the particular vehicle user accesses the secure vehicle compartment.

2. The system of claim 1, further comprising a vehicle profile database comprising a set of vehicle profile data, the set of vehicle profile data mapping a set of vehicle states with a set of secure vehicle compartment accessibility states.

3. The system of claim 1, wherein the secure vehicle compartment is an interior center console vehicle compartment.

4. The system of claim 1, wherein:
the first vehicle security sensor is a biometric sensor providing a biometric measurement of the vehicle user; and
the set of vehicle user profiles comprise biometric measurements.

5. The system of claim 1, wherein the vehicle processor is associated with a vehicle electronic control unit.

6. The system of claim 1, wherein the first vehicle security sensor communicates with a portable electronic device coupled to the vehicle user to obtain the first measurement.

7. The system of claim 6, wherein the first measurement is communicated by way of at least one of Near-Field Communication (NFC) and Bluetooth.

8. The system of claim 1, further comprising a vehicle state sensor measuring a vehicle state, wherein the secure vehicle compartment remains in a locked state based on the vehicle state.

9. A method of providing secure access to a vehicle compartment of a vehicle, comprising:
providing a first vehicle security sensor that provides a first sensor measurement of a vehicle user;
providing a user profile database that stores a set of vehicle user profiles comprising vehicle user authorization settings;
providing a secure vehicle compartment operating in a locked state and an unlocked state, the locked state being a default state;
providing a vehicle processor that receives the first sensor measurement and is in communication with each of the user profile database and the secure vehicle compartment; and
searching the user profile database to determine if the first measurement corresponds with a particular vehicle user profile in the user profile database;
wherein:
if the first measurement corresponds with the particular vehicle user profile, the particular vehicle user profile is accessed from the set of vehicle user profiles to determine if the particular vehicle user is nominally authorized to access the secured vehicle compartment; and
if the particular vehicle user is nominally authorized to access the secure vehicle compartment, the vehicle processor sets the secure vehicle compartment to the unlocked state and the particular vehicle user accesses the secure vehicle compartment.

10. The method of claim 9, further comprising the step of providing a second vehicle security sensor providing a second sensor measurement of a vehicle user, the second sensor measurement compared with the particular vehicle user profile to determine an override of a nominal authorization to access the secure vehicle compartment, wherein an override sets the secure vehicle compartment to the locked state.

11. The method of claim 10, wherein the second measurement is a measurement of a biometric of the vehicle user.

12. The method of claim 10, wherein the first sensor measurement is obtained while the vehicle user is positioned exterior to the vehicle.

13. The method of claim 9, wherein the unlocked state is temporally limited.

14. A method of multi-step vehicle user authentication to allow vehicle compartment access, the method comprising:
providing a first sensor that measures a first measurement of a user and a second sensor that measures a second measurement of the user;
providing a user profile database that stores a set of user profiles comprising user authorization settings and user authentication values, the user authorization settings comprising a vehicle access authorization and a vehicle compartment authorization;
providing a vehicle compartment coupled to a vehicle;
providing a vehicle processor that receives each of the first measurement and the second measurement and is in communication with each of the user profile database and the vehicle compartment;
matching the first measurement with a first user authentication value of a particular user profile of a particular user in the user profile database;
wherein:
a first authentication level is provided to the particular user; and
if the vehicle access authorization of the particular user profile authorizes the particular user to access the vehicle, the particular user is allowed access to the vehicle; and
matching, if the particular user is allowed access to the vehicle, the second measurement with a second user authentication value of the particular user;
wherein:
a second authentication level is provided to the particular vehicle user; and
if the vehicle compartment access authorization of the particular user profile authorizes the particular user to access the vehicle compartment, the particular user is allowed access to the vehicle compartment.

15. The method of claim 14, wherein the vehicle compartment is disposed within the vehicle.

16. The method of claim 14, wherein the vehicle compartment is disposed external to the vehicle.

17. The method of claim 14, wherein the first measurement is an identification number of a portable electronic device coupled to the particular user.

18. The method of claim 14, wherein the second measurement is a biometric measurement of the particular user.

19. The method of claim 14, wherein if the particular user is authorized to access the vehicle, a first communication is sent to a vehicle designee.

20. The method of claim 14, wherein if the particular user is authorized to access the vehicle compartment, a second communication is sent to a vehicle designee.
